(19) United States
(12) Patent Application Publication
(10) Pub. No.: US 2018/0126268 A1
(43) Pub. Date: May 10, 2018

(54) INTERACTIONS BETWEEN ONE OR MORE MOBILE DEVICES AND A VR/AR HEADSET

(71) Applicant: Zynga Inc., San Francisco, CA (US)

(72) Inventors: Gabriel Bezerra Santos, San Mateo, CA (US); Devin Kelly-Sneed, San Francisco, CA (US)

(21) Appl. No.: 15/347,509

(22) Filed: Nov. 9, 2016

(51) Int. Cl. A63F 13/428; G06F 3/01; G06T 11/60; A63F 13/212; A63F 13/525

(52) U.S. Cl. CPC A63F 13/428; G06F 3/011; G06F 3/04883; A63F 13/212; A63F 13/525; G06T 11/60

(57) ABSTRACT

A system, a machine-readable storage medium storing instructions, and a computer-implemented method are described herein for a Virtual Reality Engine that generates first object data based on a first physical gesture applied to a first object presented in a mobile device view displayed at a first mobile device. The Virtual Reality (“VR”) Engine generates second object data based on a second physical gesture applied to a second object presented in a second mobile device view displayed at a second mobile device. The VR Engine concurrently causes display of the first object and the second object in the respective mobile device views and in a virtual reality view at a virtual reality device. The VR Engine concurrently causes display of the first object data and the second object data in the respective mobile device views and the virtual reality view.

### TECHNICAL FIELD

The subject matter disclosed herein generally relates to the technical field of special-purpose machines that facilitate customizing one or more virtual environments, including software-configured computerized variants of such special-purpose machines and improvements to such variants, and to the technologies by which such special-purpose machines become improved compared to other special-purpose machines that facilitate customizing one or more virtual environments BACKGROUND

In many games, there is a virtual world or some other imagined playing space where a player/user of the game controls one or more player characters (herein “character,” “player character,” or “PC”). Player characters can be considered in-game representations of the controlling player. As used herein, the terms “player,” “user,” “entity,” and “friend” may refer to the in-game player character controlled by that player, user, entity, or friend, unless context suggests otherwise. The game display can display a representation of the player character. A game engine accepts inputs from the player, determines player character actions, decides outcomes of events and presents the player with a game display illuminating what happened. In some games, there are multiple players, wherein each player controls one or more player characters.

In many computer games, there are various types of in-game assets (aka “rewards” or “loot”) that a player character can obtain within the game. For example, a player character may acquire game points, gold coins, experience points, character levels, character attributes, virtual cash, game keys, or other in-game items of value. In many computer games, there are also various types of in-game obstacles that a player must overcome to advance within the game. In-game obstacles can include tasks, puzzles, opponents, levels, gates, actions, etc. In some games, a goal of the game may be to acquire certain in-game assets, which can then be used to complete in-game tasks or to overcome certain in-game obstacles. For example, a player may be able to acquire a virtual key (i.e., the in-game asset) that can then be used to open a virtual door (i.e., the in-game obstacle).

An electronic social networking system typically operates with one or more social networking servers providing interaction between users such that a user can specify other users of the social networking system as “friends.” A collection of users and the “friend” connections between users can form a social graph that can be traversed to find second, third and more remote connections between users, much like a graph of nodes connected by edges can be traversed.

Many online computer games are operated on an online social networking system. Such an online social networking system allows both users and other parties to interact with the computer games directly, whether to play the games or to retrieve game- or user-related information. Internet users may maintain one or more accounts with various service providers, including, for example, online game networking systems and online social networking systems. Online systems can typically be accessed using browser clients (e.g., Firefox, Chrome, Internet Explorer).

### BRIEF DESCRIPTION OF THE DRAWINGS

FIG. 1 is a schematic diagram showing an example of a system, according to some example embodiments.

FIG. 2 is a schematic diagram showing an example of a social network within a social graph, according to some embodiments.

FIG. 3 is a block diagram illustrating components of a VR Engine, according to some example embodiments.

FIG. 4 is a block diagram illustrating an example of a mobile device view, according to some example embodiments.

FIG. 5 is a block diagram illustrating an example of a virtual reality view, according to some example embodiments.

FIG. 6 is a block diagram illustrating an example of a virtual reality view, according to some example embodiments.

FIG. 7 is a block diagram illustrating an example of a mobile device view, according to some example embodiments.

FIG. 8 is a flowchart showing an example method according to some example embodiments.

FIG. 9 is a flowchart showing an example method according to some example embodiments.

FIG. 10 is a diagrammatic representation of an example data flow between example components of the example system of FIG. 1, according to some example embodiments.

FIG. 11 illustrates an example computing system architecture, which may be used to implement a server or a client system illustrated in FIG. 10, according to some example embodiments.

FIG. 12 illustrates an example network environment, in which various example embodiments may operate.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter.

Various embodiments disclosed herein are directed to a The Virtual Reality Engine generates first object data based on a first physical gesture applied to a display position of a first object presented in a first instance of a mobile device view of a virtual environment displayed at a first mobile device. The Virtual Reality (“VR”) Engine generates second object data based on a second physical gesture applied to a display position of a second object presented in a second instance of the mobile device view of the virtual environment displayed at a second mobile device. The VR Engine concurrently causes display of the first object and the second object in the first and second instances of the mobile device view and in a virtual reality view of the virtual environment displayed at a virtual reality device. The VR Engine concurrently causes display of the first object data and the second object data in the first and second instances of the mobile device view and the virtual reality view.

In exemplary embodiments, the VR Engine concurrently causes display of game actions across multiple mobile devices and multiple virtual reality devices. Each game action is displayed according to a visual perspective of a player that corresponds with a particular mobile device or a particular virtual reality device. That is, for example, a game action is displayed in a mobile device view as producing a result of a game object traveling away from a visual perspective of a player associated with a mobile device. The same game action is concurrently displayed in a virtual reality view as producing a result of the game object traveling towards a perspective of a player associated with a virtual reality device.

In exemplary embodiments, the VR Engine generates a gaming environment that generates game object data based on physical gestures applied to respective surfaces of multiple mobile devices and game object data based on one or more characteristics of physical movements detected by a VR device operating according to a virtual reality platform (“VR device”). A characteristic of a physical movement (or gesture) can be a direction of a finger swipe, a duration of a finger swipe, a pressure of a finger swipe, a speed of a finger swipe, a path of a finger swipe and a pattern of a finger swipe. The VR Engine generates game object data by translating the one or more characteristics of a physical movement to a game action according to one or more game rules.

In exemplary embodiments, a first mobile device corresponds to a first player in the gaming environment of the VR Engine. A second mobile device corresponds to a second player in the gaming environment. A VR device corresponds to a third player (“VR player”) in the gaming environment. It is understood that, in exemplary embodiments, one or modules of the VR Engine are installed at and executed by each of the first mobile device, the second mobile device and the VR device. One or modules of the VR Engine can also be installed in a server computing device in communication with the second mobile device and the VR device.

Although the above example embodiments described as being implemented via a web browser on a client device, it is to be noted that a game display may in some embodiments be provided by a virtual reality (VR) display or an augmented reality (AR) display. AR comprises a live direct or indirect view of a physical, real-world environment whose elements are augmented (or supplemented) by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. An augmented reality gaming device may allow players to interact with visual elements thus overlaid on the view of reality. Augmentation may be performed in real-time and may comprise overlaying on the view of reality one or more user interface elements that can be selected a manipulated by the user, and may further comprise overlaying on the view of reality game objects and/or character with which the player can interact during gameplay.

Virtual Reality (VR), which can be referred to as immersive multimedia or computer-simulated life, replicates an environment that simulates physical presence in places in the real world or imagined worlds and lets the user interact in that world. Virtual reality artificially creates sensory experiences, which can include sight, hearing, touch, smell, taste, and more. Virtual reality environments can be displayed either on a computer screen or with special stereoscopic displays, and some simulations include additional sensory information and focus on real sound through speakers or headphones targeted towards VR users. Some advanced, haptic, systems now include tactile information, generally known as force feedback in medical, gaming and military applications. Furthermore, virtual reality covers remote communication environments which provide virtual presence of users with the concepts of telepresence and telexistence or a virtual artifact (VA) either through the use of standard input devices such as a keyboard and mouse, or through multimodal devices such as a wired glove or omnidirectional treadmills. The simulated gaming environment displayed to the user by use of a virtual reality gaming device can for some games be similar to the real world in order to create a lifelike experience, while the virtual gaming environment seemingly inhabited by the player during VR gameplay may in other embodiments be stylized environments that differ significantly from reality

It is understood that various embodiments include the generation of one or more modules that comprise source code that, when compiled by a computing device(s), creates object code that causes the computing device(s) to perform one or more operations described herein. In other embodiments, any of the modules comprise object code that causes the computing device(s) to perform various operations described herein. In some embodiments, each module(s) can be permanently configured circuitry, such as ASICs, etc.

Other embodiments include the generation of one or more modules that comprise source code that, when compiled by a client computing device(s), creates object code that causes the client computing device(s) to perform one or more operations described herein in communication with a server computing devices(s). In other embodiments, any of the modules comprise object code that causes the client computing device(s) to perform various operations described herein in communication with the server computing devices(s).

Other embodiments include the generation of one or more modules that comprise source code that, when compiled by a server computing device(s), creates object code that causes the server computing device(s) to perform one or more operations described herein in communication with one or more client computing devices. In other embodiments, any of the modules comprise object code that causes the server computing device(s) to perform various operations described herein in communication with the one or more client computing devices.

### Social Network Systems and Game Networking Systems

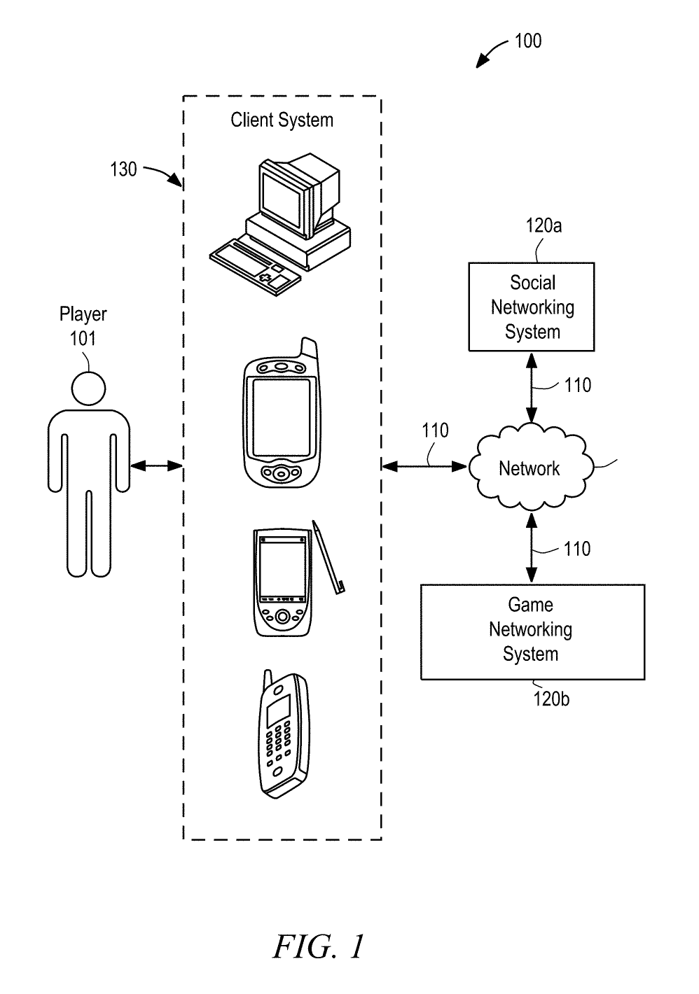

FIG. 1 illustrates an example of a system for implementing various disclosed embodiments. In particular embodiments, system 100 comprises player 101, social networking system 120a, game networking system 120b (i.e. online gaming system), client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a (i.e. social network system) is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 101 may use client system 130 to access, send data to, and receive data from social networking system 120a and game networking system 120b. Client system 130 can access social networking system 120a or game networking system 120b directly, via network 160, or via a third-party system. As an example and not by way of limitation, client system 130 may access game networking system 120b via social networking system 120a. Client system 130 can be any suitable computing device, such as a personal computer, laptop, cellular phone, smart phone, computing tablet, etc.

Although FIG. 1 illustrates a particular number of players 101, social network systems 120a, game networking systems 120b, client systems 130, and networks 160, this disclosure contemplates any suitable number of players 101, social network systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of player 101, social networking system 120a, game networking system 120b, client system 130, and network 160, this disclosure contemplates any suitable arrangement of player 101, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 120a, game networking system 120b, client system 130, and network 160, this disclosure contemplates any suitable connections between player 101, social networking system 120a, game networking system 120b, client system 130, and network 160. As an example and not by way of limitation, in particular embodiments, client system 130 may have a direct connection to social networking system 120a or game networking system 120b, bypassing network 160.

### Online Games and Game Systems

Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120b (i.e. online gaming system), which includes a Notification Generator 150 that performs operations according to embodiments as described herein. The game networking system 120b can be accessed using any suitable connection with a suitable client system 130. A player may have a game account on game networking system 120b, wherein the game account can contain a variety of information associated with the player (e.g., the player's personal information, financial information, purchase history, player character state, game state). In some embodiments, a player may play multiple games on game networking system 120b, which may maintain a single game account for the player with respect to all the games, or multiple individual game accounts for each game with respect to the player. In some embodiments, game networking system 120b can assign a unique identifier to each player 101 of an online game hosted on game networking system 120b. Game networking system 120b can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmitting user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the player, updating and/or synchronizing the game state based on the game logic and each input from the player, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120b.

### Storing Game-Related Data

A database may store any data relating to game play within a game networking system 120b. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 120b may determine the player's friend preferences based on player attributes that the player's first-degree friends have in common, and may store these player attributes as friend preferences in the player profile. Furthermore, the game networking system 120b may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 120b may determine the player's likelihood to lead value based on information from other players that interact with this player. For example, the game networking system 120b may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 120b may also determine the player's likelihood to lead value based on information about the player's interactions with others and the outcome of these interactions. For example, the game networking system 120b may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 120b may determine the player's likelihood to lead value based on determining a likelihood for the other players to perform a certain action in response to interacting or communicating with the player and/or the player's virtual environment.

### Game Systems, Social Networks, and Social Graphs:

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player.

In particular embodiments, player 101 may access particular game instances of an online game. A game instance is copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses game instance associated with another player, such as Whiteacre Farm, the game engine may not allow the first player to plant crops in that game instance. However, other in-game actions may be available to the first player, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 120a or game networking system 120b). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120b, which is managed by the game operator. In other embodiments, the social graph is part of a social networking system 120a managed by a third-party (e.g., Facebook, Friendster, Myspace). In yet other embodiments, player 101 has a social network on both game networking system 120b and social networking system 120a, wherein player 101 can have a social network on the game networking system 120b that is a subset, superset, or independent of the player's social network on social networking system 120a. In such combined systems, game network system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

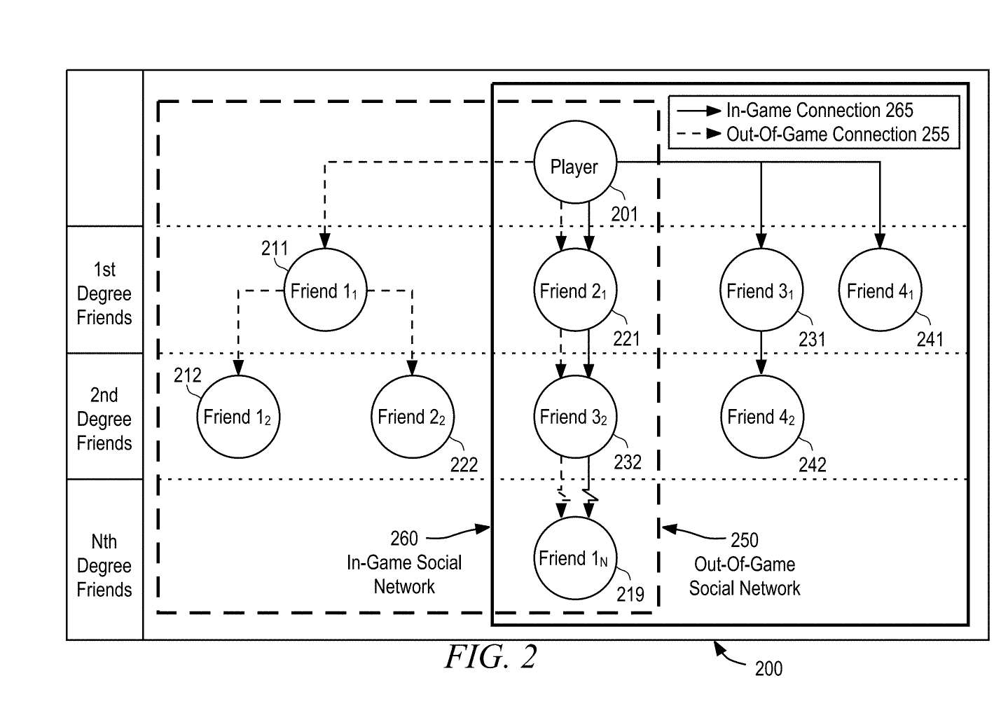

FIG. 2 shows an example of a social network within a social graph. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player,” “user” and “account” can be used interchangeably and can refer to any user or character in an online game networking system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

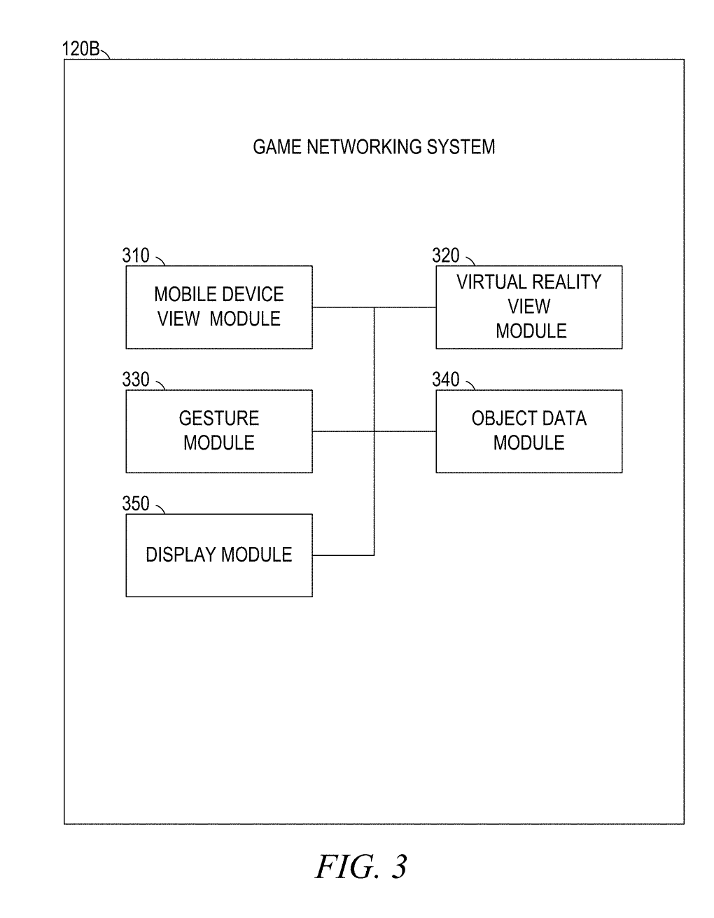

FIG. 3 is a block diagram illustrating components of a VR Engine, according to some example embodiments. The game networking system 120b includes the VR Engine. The VR Engine includes at least a mobile device view module 310, a virtual reality view module 320, a gesture module 330, an object data module 340 and a display module 350.

In various example embodiments, the mobile device view module 310, is a hardware-implemented module that controls, manages and stores information related to the generation of one or mobile device views for respective mobile devices. Each mobile device view is generated according to a visual perspective of a particular player that corresponds with a respective mobile device.

In various example embodiments, the virtual reality view module 320 is a hardware-implemented module that controls, manages and stores information related to generating of a virtual reality view for a virtual reality device. The virtual reality view is generated according to a visual perspective of a player associated with the virtual reality device.

In various example embodiments, the gesture module 330, is a hardware-implemented module that controls, manages and stores information related to detecting physical gestures (or movements) at each mobile device, each virtual reality input device and a virtual reality headset.

In various example embodiments, the object data module 340 may be a hardware-implemented module that controls, manages and stores information related to generating object data based on one or more gestures detected at each mobile device, each virtual reality input device and a virtual reality headset. The object data is based on characteristics (pressure, duration, speed, angle, direction, path, pattern) of one or more detected gestures (or physical movements). In example embodiments, object data is an animation of a game action resulting from one or more detected gestures (or movements).

In various example embodiments, the display module 350 is a hardware-implemented module that controls, manages and stores information related to concurrent display mobile device views and a virtual reality view. The object data is included in such concurrent display according to visual perspectives of different players.

The modules 310-350 are configured to communicate with each other (e.g., via a bus, shared memory, or a switch). Any one or more of the modules 310-350 described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

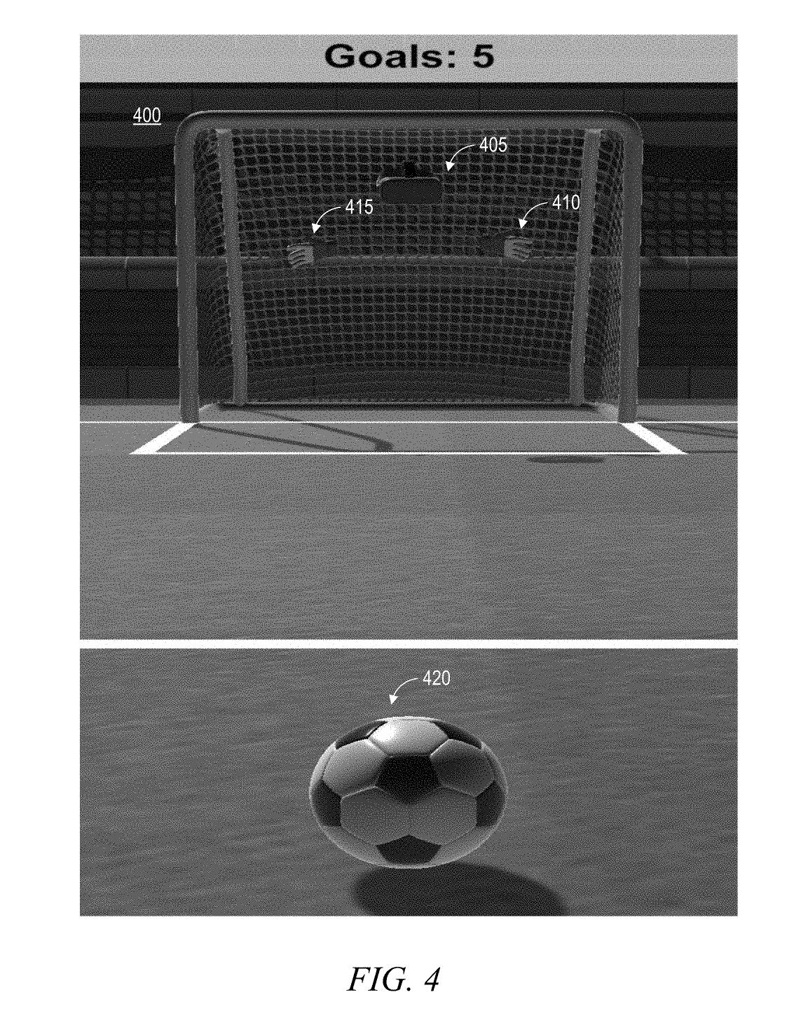

FIG. 4 is a block diagram illustrating an example of a mobile device view, according to some example embodiments.

The VR Engine generates an instance of a mobile device view 400 of the virtual environment according to a visual perspective of a first player. The VR Engine causes display of the mobile device view 400 on a display screen of a mobile device associated with the first player. For example, the VR Engine transmits at least a portion of animation data of the mobile device view 400 to the mobile device associated with the first player.

The mobile device view 400 includes a representation of a player associated with a VR device. The representation of the player associated with the VR device includes a representation of a VR headset 405, a representation of a first VR input device, 410 and a representation of a second VR input device 415. For example, the player associated with the VR device is assigned a role of a soccer goalie in the virtual environment. The representations of the VR input devices 410, 415 can be displayed in the mobile device view 400 as a pair of gloved hands of the soccer goalie. It is understood that representations of the VR input devices 410, 415 are concurrently displayed—according to different respective visual perspectives—in one or more mobile device views and a VR view of the virtual environment displayed at the VR device.

The mobile device view 400 includes a representation of a game object 420, such as a soccer ball (or any type of animated object that moves within the virtual environment). The VR Engine detects a physical gesture applied to a physical display screen of the mobile device associated with the first player. The physical gesture is applied to a display position of at least a portion of the game object 420. For example, the physical gesture is a finger swipe that begins at the display position of the game object 420 and travels a path that is directed towards the representation of the player associated with the VR device.

Based on the detected physical gesture, the VR Engine generates game object data for the mobile device view 400. For example, the physical gesture is a finger swipe that travels towards the representation of the player associated with the VR device. The finger swipe has a particular pressure, path, duration and speed. The VR Engine accesses one or more gaming rules to translate the finger swipe's pressure path, duration and speed. As a result of the one or more gaming rules, the VR Engine creates first game object data, which is animation data for display in the mobile device view 400 representing the first game object traveling towards the representation of the player associated with the VR device. The representation of how the game object travels is derived from (and/or proportional to) the finger swipe's pressure, path, duration and speed.

From the visual perspective of the first player, the game object will appear as traveling away from the first player. The VR Engine also generates second game object data based on the physical gesture for the VR view. For example, the second game object data for the VR view is animation data representing the game object traveling towards the representation of the player associated with the VR device. From the visual perspective of the player associated with the VR device, the game object will appear as traveling towards the player of the VR device. The VR Engine causes concurrent display of the first game object data for the mobile device view 400 and the second game object data for the VR view. The first and second game object data are both derived from (and/or proportional to) the finger swipe's pressure, path, duration and speed. It is understood that, in exemplary embodiments, the VR Engine generates first game object data for a first physical gesture detected at a first mobile device and second game object data for a second physical gesture detected at a second mobile device. The VR Engine causes concurrent display of the first object data and the second object data in each mobile device view and the VR view—in accordance with different respective player visual perspectives.

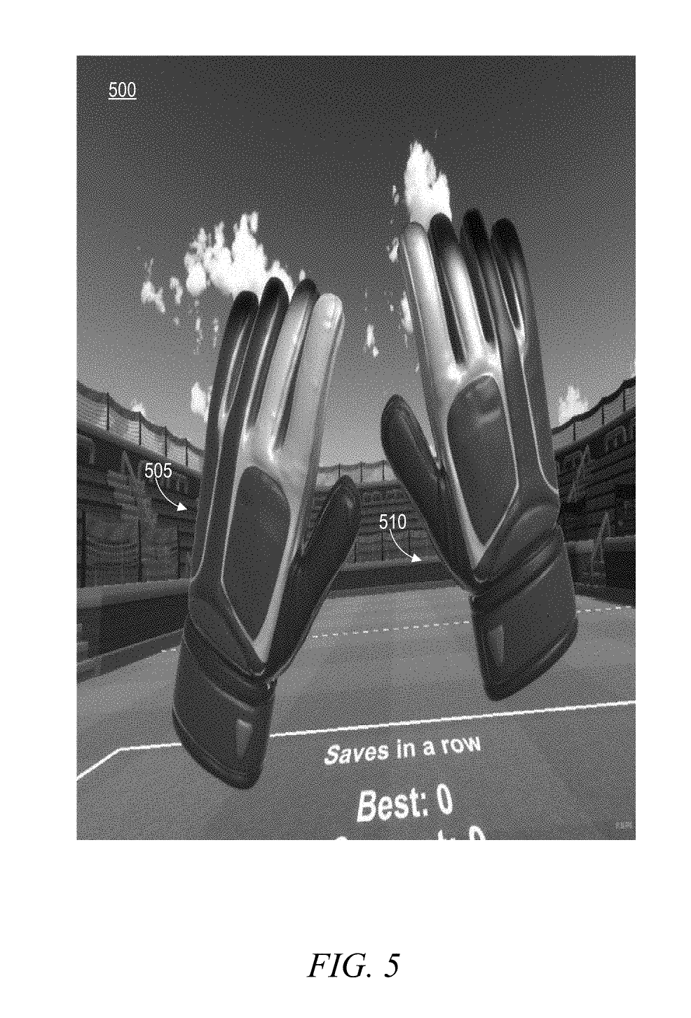

FIG. 5 is a block diagram illustrating an example of a virtual reality view, according to some example embodiments. The VR Engine generates a VR view 500 of the virtual environment according to a visual perspective of a player associated with a VR device. The VR view 500 includes a portion of a representation of the player associated with the VR device. For example, the VR view 500 includes representations 505, 510 of VR input devices but does not include a representation of a VR headset (such as VR headset representation 405 in FIG. 4). The representations 505, 510 of VR input devices depict soccer goalie gloves from a visual perspective of the player associated with the VR device. Display of the representations 505, 510 of VR input devices are modified based on physical actions detected by the VR input device. For example, the VR Engine detects lateral movement of a VR input device and the VR Engine updates the corresponding representation of the VR input device to depict lateral movement of a soccer goalie glove. The VR Engine also concurrently causes display of the lateral movement of the soccer goalie glove in the mobile device view 400 from the visual perspective of the first player. It is understood that although VR view 500 is depicted by FIG. 5. without a game object, one or more game objects can be displayed by the VR Engine in the VR view 500. It is further understood that the VR Engine causes display of the VR view 500 at a VR device concurrently with causing display of the mobile device views at respective mobile devices that correspond to different players.

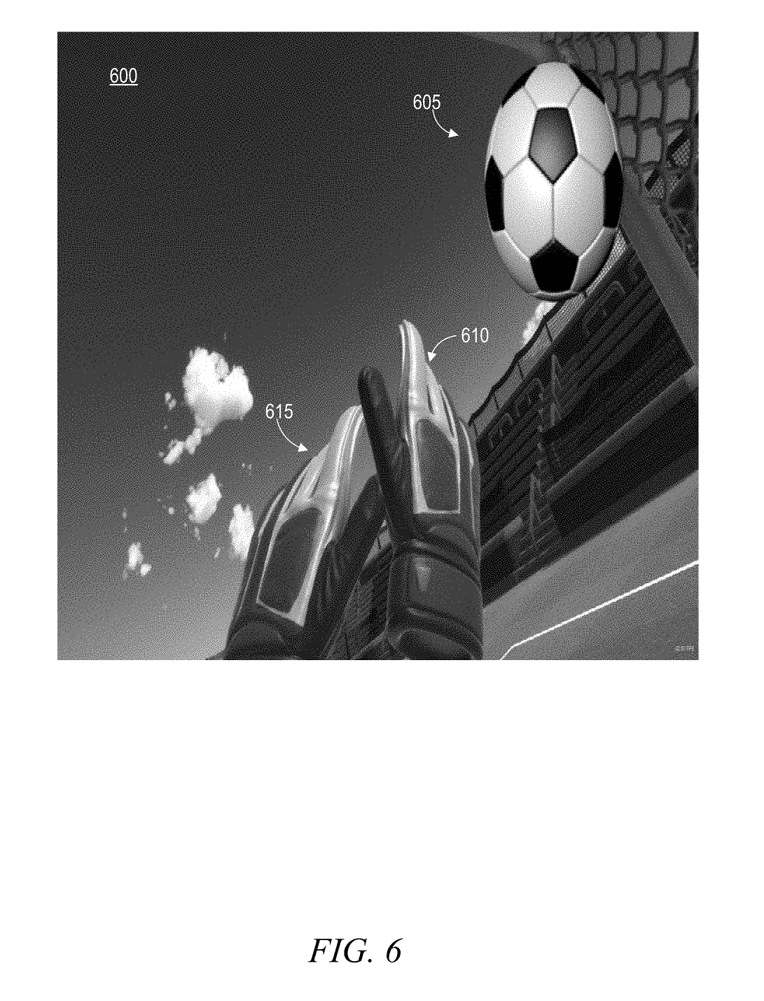

FIG. 6 is a block diagram illustrating an example of a virtual reality view, according to some example embodiments. The VR Engine generates a VR view 600 of the virtual environment according to a visual perspective of a player associated with a VR device. The VR view 600 includes a portion of a representation of the player associated with the VR device. For example, the VR view 600 includes representations 610, 615 of VR input devices but does not include a representation of a VR headset (such as VR headset representation 405). The representations 610, 615 of VR input devices depict soccer goalie gloves from a visual perspective of the player associated with the VR device.

Display of the representations 610, 615 of VR input devices are modified based on physical actions detected at each VR input device. For example, the VR Engine detects concurrent movement of both VR input devices and the VR Engine updates the corresponding representations 610, 615 of the VR input devices in accordance with one or more characteristics (such as speed, direction, path, pattern) of movements of each VR input device. For example, the VR Engine depicts soccer goalie gloves attempting to perform a blocking game action on game object 605 (such as a soccer ball) traveling towards the representation of the player associated with the VR device. The animation of the blocking game action is a result of translating the one or more characteristics of movements, detected at each VR input device, according to one or more gaming rules. In one embodiment, VR input device movement is represented according to data representing three-dimensions. That is, an instance of a movement of a respective VR input device is represented by data on an x, y, and z axis. The VR Engine also causes display of the concurrent movement of the soccer goalie gloves in the mobile device view 400 from the visual perspective of the first player.

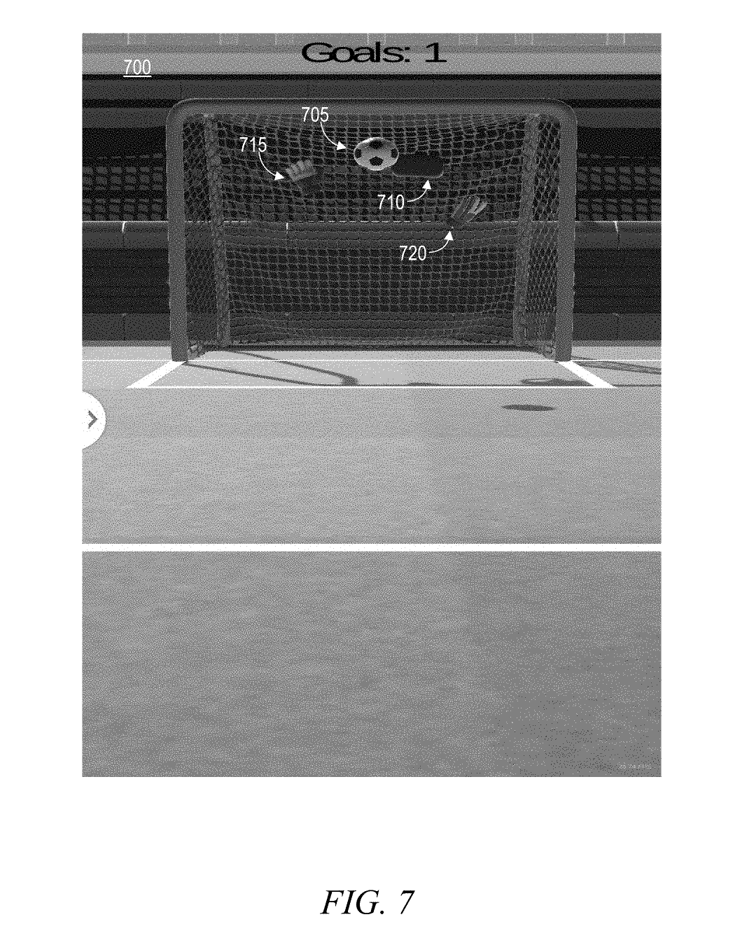

FIG. 7 is a block diagram illustrating an example of a mobile device view, according to some example embodiments. The VR Engine generates a mobile device view 700 of the virtual environment according to a visual perspective of a player associated with a mobile device. The mobile device view 700 includes a representation of the player associated with the VR device. For example, the mobile device view 700 includes representations 715, 720 of VR input devices and includes a representation 710 of a VR headset. The representations 715, 720 of VR input devices depict soccer goalie gloves from a visual perspective of the player associated with the mobile device.

Display of the representations 715, 720 of VR input devices are modified based on physical actions detected at each VR input device. In addition, display of the representation 710 of the VR headset is modified based on physical actions detected at the VR headset. For example, the VR Engine concurrently detects respective movements of both VR input devices and movement of the VR headset. The VR Engine updates, according to one or more gaming rules, the corresponding representations 715, 720 of the VR input devices in accordance with one or more characteristics (such as speed, direction, path, pattern) of respective movements of each VR input device. In addition, the VR Engine updates, according to one or more gaming rules, the representation 710 of the VR headset in accordance with one or more characteristics (such as speed, direction, path, pattern, angle) of one or movements detected at the VR headset. The mobile device view 700 further includes game object data that is, for example, animation data for display of a soccer ball traveling towards the representation 710 of a VR headset from a visual perspective of the player associated with the mobile device.

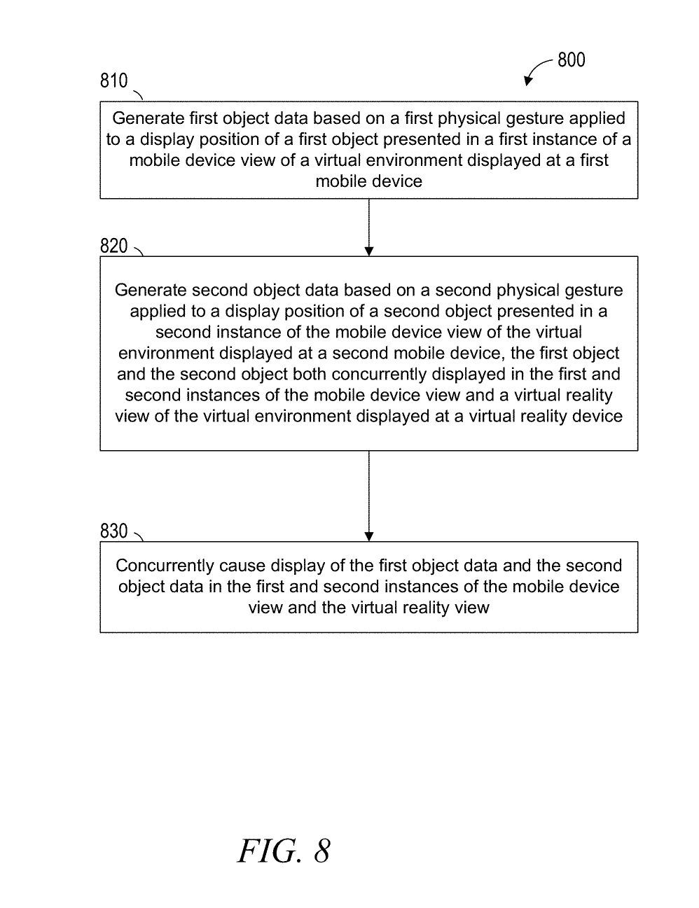

FIG. 8 is a flowchart showing an example method 800 according to some example embodiments.

At operation 810, the VR Engine generates first object data based on a first physical gesture applied to a display position of a first object presented in a first instance of a mobile device view of a virtual environment displayed at a first mobile device.

At operation 820, the VR Engine generates second object data based on a second physical gesture applied to a display position of a second object presented in a second instance of the mobile device view of the virtual environment displayed at a second mobile device, the first object and the second object both concurrently displayed in the first and second instances of the mobile device view and a virtual reality view of the virtual environment displayed at a virtual reality device.

At operation 830, the VR Engine concurrently causes display of the first object data and the second object data in the first and second instances of the mobile device view and the virtual reality view.

Based on execution of operations 810-830, the VR Engine generates a mobile device view of a gaming environment for presentation on one or more mobile devices. The VR Engine generates a VR view of the gaming environment for presentation at a VR device. The mobile device view includes a representation of each player that corresponds with a respective mobile device and a full representation of the VR player. The VR view includes a representation of each player that corresponds with a respective mobile device and a portion of the representation of the VR player.

The VR Engine detects a first physical gesture applied to a surface, such as a display screen, of a first mobile device and detects a second physical gesture applied to a surface of a second mobile device. The VR Engine receives first gesture data representative of the first physical gesture and second gesture data representative of the second physical gesture. The VR Engine generates first game object data based on the first gesture data and second game object data based on the second gesture data. The VR Engine causes concurrent display of the first game object data and the second game object data on each of the first mobile device, the second mobile device and the VR device. Such concurrent display is rendered by the VR Engine according to the first player's visual perspective of the mobile device view at the first mobile device, rendered according to the second player's visual perspective of the mobile device view at the second mobile device and rendered according to the VR player's visual perspective of the VR view at the VR device.

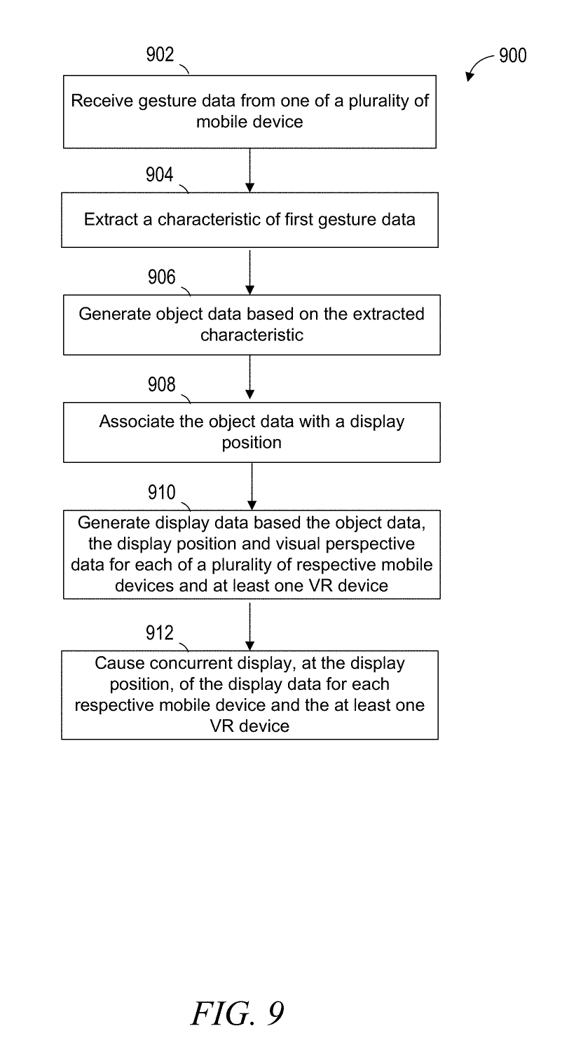

FIG. 9 is a flowchart 900 showing an example method according to some example embodiments.

At operation 902, the VR Engine receives gesture data from one of a plurality of mobile device. For example, a physical gesture, such as a plurality of finger taps are detected at a mobile device associated with a first player. The finger taps have a particular pattern, duration, and/or speed. In addition, the finger taps occurred at a display position of a user interface displayed on the mobile device. For example, the display position is a current display position of a virtual object (such as a selectable game object).

At operation 904, the VR Engine extracts a characteristic of first gesture data. The VR Engine accesses one or more gaming rules to translate the finger taps', pattern, duration and/or speed into one or more game animations applied to the virtual object. In addition, one or more gaming rules can be associated with the display position such that a particular subset of gaming rules are applied to the finger taps', pattern, duration and/or speed on the basis of the virtual object's display position. For example, the finger taps correspond with a first type of game behavior when detected at a display position within a first portion of the user interface, whereas the finger taps correspond with a second type of game behavior when detected at a display position within a second portion of the user interface.

At operation 906, the VR Engine generates object data based on the extracted characteristic. As a result of the one or more gaming rules, the VR Engine creates game object data. For example, the object data is game object data for animation involving the virtual object according to a player's visual perspective in mobile device view or a VR view. The animation involving the virtual object is derived from (and/or proportional to) the characteristics (pattern, duration, speed) of the finger taps.

At operation 908, the VR Engine associates the object data with a display position. It is understood that each mobile device view is associated with a respective mobile device from a plurality of mobile devices. A VR view is associated with a VR device from a plurality of VR devices. A virtual environment is presented on each mobile device according to a visual perspective of a player associated with the mobile device. Therefore, each mobile device renders the virtual environment according to a different visual perspective. The virtual environment is presented on each VR device according to a visual perspective of a player associated with the VR device. Therefore, each VR device renders the virtual environment according to a different visual perspective as well.

However, the gesture data is based on a physical gesture that was applied to a particular display position at a mobile device upon which the physical gesture occurred. As such, the object data is to be presented on all mobile devices and all VR devices with respect to that display position. The VR Engine creates an association, or a data relationship, between the object data and the display position.

At operation 910, the VR Engine generates display data based the object data, the display position and visual perspective data for each of a plurality of respective mobile devices and at least one VR device. In some embodiments, display data is generated for each mobile device and each VR device. For example, first display data for a first mobile device is generated such that the animation represented by the game object data will occur at the display position in a mobile device view of a virtual environment rendered according to a visual perspective associated with a first player. Second display data for a second mobile device is generated such that the animation represented by the game object data will occur at the display position in a mobile device view of the virtual environment rendered according to a visual perspective associated with a second player. Third display data for a first VR device is generated such that the animation represented by the game object data will occur at the display position in a first VR view of the virtual environment rendered according to a visual perspective associated with a first VR player.

At operation 912, the VR Engine causes concurrent display, at the display position, of the display data for each respective mobile device and the at least one VR device. The VR Engine provides the first display data to the first mobile device, the second display data to the second mobile device and the third display data to the first VR device.

### Data Flow

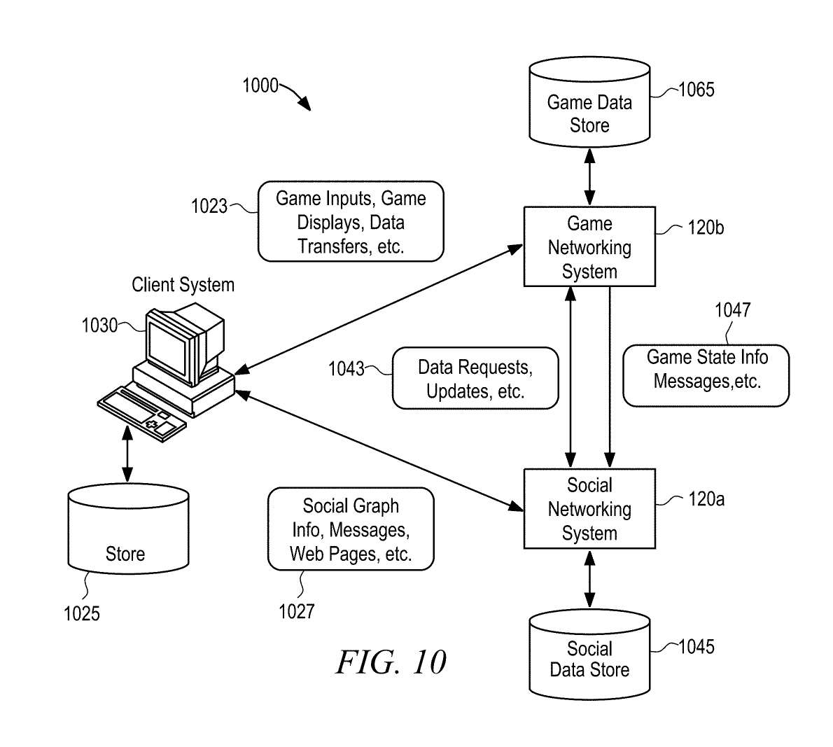

FIG. 10 illustrates an example data flow between the components of system 900. In particular embodiments, system 1000 can include client system 1030, social networking system 120a (i.e. social network system), and game networking system 120b (i.e. online game system system). The components of system 1000 can be connected to each other in any suitable configuration, using any suitable type of connection. The components may be connected directly or over any suitable network. Client system 1030, social networking system 120a, and game networking system 120bb can each have one or more corresponding data stores such as local data store 1035, social data store 1045, and game data store 1065, respectively. Social networking system 120a and game networking system 120b can also have one or more servers that can communicate with client system 1030 over an appropriate network. Social networking system 120a and game networking system 120b can have, for example, one or more internet servers for communicating with client system 1030 via the Internet. Similarly, social networking system 120a and game networking system 120b can have one or more mobile servers for communicating with client system 1030 via a mobile network (e.g., GSM, PCS, Wi-Fi, WPAN, etc.). In some embodiments, one server may be able to communicate with client system 1030 over both the Internet and a mobile network. In other embodiments, separate servers can be used.

Client system 1030 can receive and transmit data 1023 to and from game networking system 120b. This data can include, for example, webpages, messages, game inputs, game displays, HTTP packets, data requests, transaction information, updates, and other suitable data. At some other time, or at the same time, game networking system 120b can communicate data 1043, 1047 (e.g., game state information, game system account information, page info, messages, data requests, updates, etc.) with other networking systems, such as social networking system 120a (e.g., Facebook, Myspace, etc.). Client system 1030 can also receive and transmit data 1027 to and from social networking system 120a. This data can include, for example, webpages, messages, social graph information, social network displays, HTTP packets, data requests, transaction information, updates, and other suitable data.

Communication between client system 1030, social networking system 120a, and game networking system 120b can occur over any appropriate electronic communication medium or network using any suitable communications protocols. For example, client system 1030, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTPS, FTP, SNMP, TELNET, and a number of other protocols, may be used. In some embodiments, no protocol may be used and, instead, transfer of raw data may be utilized via TCP or User Datagram Protocol. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 120b, the BLOB containing the game state for the instance corresponding to the player can be transmitted to client system 1030 for use by a client-side executed object to process. In particular embodiments, the client-side executable may be a FLASH-based game, which can de-serialize the game state data in the BLOB. As a player plays the game, the game logic implemented at client system 1030 maintains and modifies the various game state parameters locally. The client-side game logic may also batch game events, such as mouse clicks, and transmit these events to game networking system 120b. Game networking system 120b may itself operate by retrieving a copy of the BLOB from a database or an intermediate memory cache (memcache) layer. Game networking system 120b can also de-serialize the BLOB to resolve the game state parameters and execute its own game logic based on the events in the batch file of events transmitted by the client to synchronize the game state on the server side. Game networking system 120b may then re-serialize the game state, now modified, into a BLOB and pass this to a memory cache layer for lazy updates to a persistent database.

With a client-server environment in which the online games may run, one server system, such as game networking system 120b, may support multiple client systems 1030. At any given time, there may be multiple players at multiple client systems 1030 all playing the same online game. In practice, the number of players playing the same game at the same time may be very large. As the game progresses with each player, multiple players may provide different inputs to the online game at their respective client systems 1030, and multiple client systems 1030 may transmit multiple player inputs and/or game events to game networking system 120b for further processing. In addition, multiple client systems 1030 may transmit other types of application data to game networking system 120b.

In particular embodiments, a computed-implemented game may be a text-based or turn-based game implemented as a series of web pages that are generated after a player selects one or more actions to perform. The web pages may be displayed in a browser client executed on client system 1030. As an example and not by way of limitation, a client application downloaded to client system 1030 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1030, either caused by an action of a game player or by the game logic itself, client system 1030 may need to inform game networking system 120b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1000 is discussed in reference to updating a multi-player online game hosted on a network-addressable system (such as, for example, social networking system 120a or game networking system 120b), where an instance of the online game is executed remotely on a client system 1030, which then transmits application event data to the hosting system such that the remote game server synchronizes game state associated with the instance executed by the client system 1030.

In particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 1030 may include a Flash client. The Flash client may be configured to receive and run Flash application or game object code from any suitable networking system (such as, for example, social networking system 120a or game networking system 120b). In particular embodiments, the Flash client may be run in a browser client executed on client system 1030. A player can interact with Flash objects using client system 1030 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1030, the Flash client may send the events that caused the game state changes to the in-game object to game networking system 120b. However, to expedite the processing and hence the speed of the overall gaming experience, the Flash client may collect a batch of some number of events or updates into a batch file. The number of events or updates may be determined by the Flash client dynamically or determined by game networking system 120b based on server loads or other factors. For example, client system 1030 may send a batch file to game networking system 120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1030. In particular embodiments, the batch file may be a text file and the name-value pairs may be in string format.

In particular embodiments, when a player plays an online game on client system 1030, game networking system 120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 120b may retrieve the corresponding BLOB from the database to determine the most-recent values of the game-related data. In particular embodiments, while a player is playing the online game, game networking system 120b may also load the corresponding BLOB into a memory cache so that the game system may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

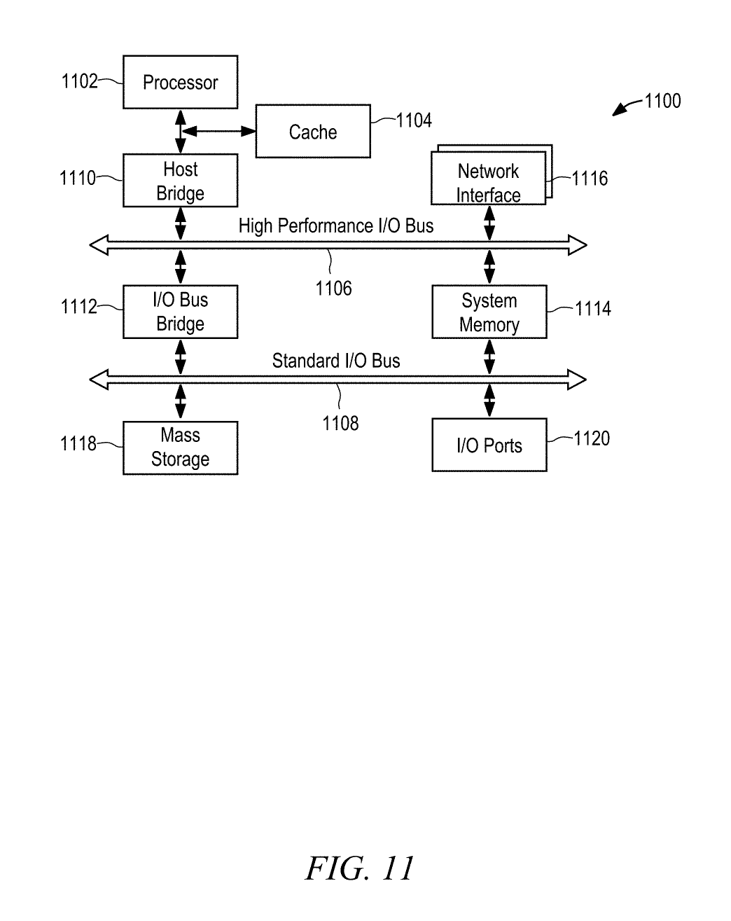

FIG. 11 illustrates an example computing system architecture, which may be used to implement a server 1022 or a client system 1030 illustrated in FIG. 10. In one embodiment, hardware system 1100 comprises a processor 1102, a cache memory 1104, and one or more executable modules and drivers, stored on a tangible computer readable medium, directed to the functions described herein. Additionally, hardware system 1100 may include a high performance input/output (I/O) bus 1106 and a standard I/O bus 1108. A host bridge 1110 may couple processor 1102 to high performance I/O bus 1106, whereas I/O bus bridge 1112 couples the two buses 1106 and 1108 to each other. A system memory 1114 and one or more network/communication interfaces 1116 may couple to bus 1106. Hardware system 1100 may further include video memory (not shown) and a display device coupled to the video memory. Mass storage 1118 and I/O ports 1120 may couple to bus 1108. Hardware system 1100 may optionally include a keyboard, a pointing device, and a display device (not shown) coupled to bus 1108. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1100 are described in greater detail below. In particular, network interface 1116 provides communication between hardware system 1100 and any of a wide range of networks, such as an Ethernet (e.g., IEEE 802.3) network, a backplane, etc. Mass storage 1118 provides permanent storage for the data and programming instructions to perform the above-described functions implemented in servers 1122, whereas system memory 1114 (e.g., DRAM) provides temporary storage for the data and programming instructions when executed by processor 1102. I/O ports 1120 are one or more serial and/or parallel communication ports that provide communication between additional peripheral devices, which may be coupled to hardware system 1100.

Hardware system 1100 may include a variety of system architectures and various components of hardware system 1100 may be rearranged. For example, cache 1104 may be on-chip with processor 1102. Alternatively, cache 1104 and processor 1102 may be packed together as a “processor module,” with processor 1102 being referred to as the “processor core.” Furthermore, certain embodiments of the present disclosure may not require nor include all of the above components. For example, the peripheral devices shown coupled to standard I/O bus 1108 may couple to high performance I/O bus 1106. In addition, in some embodiments, only a single bus may exist, with the components of hardware system 1100 being coupled to the single bus. Furthermore, hardware system 1100 may include additional components, such as additional processors, storage devices, or memories.

An operating system manages and controls the operation of hardware system 1100, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit. Particular embodiments may operate in a wide area network environment, such as the Internet, including multiple network addressable systems.

FIG. 11 illustrates an example network environment, in which various example embodiments may operate. Network cloud 1160 generally represents one or more interconnected networks, over which the systems and hosts described herein can communicate. Network cloud 860 may include packet-based wide area networks (such as the Internet), private networks, wireless networks, satellite networks, cellular networks, paging networks, and the like.

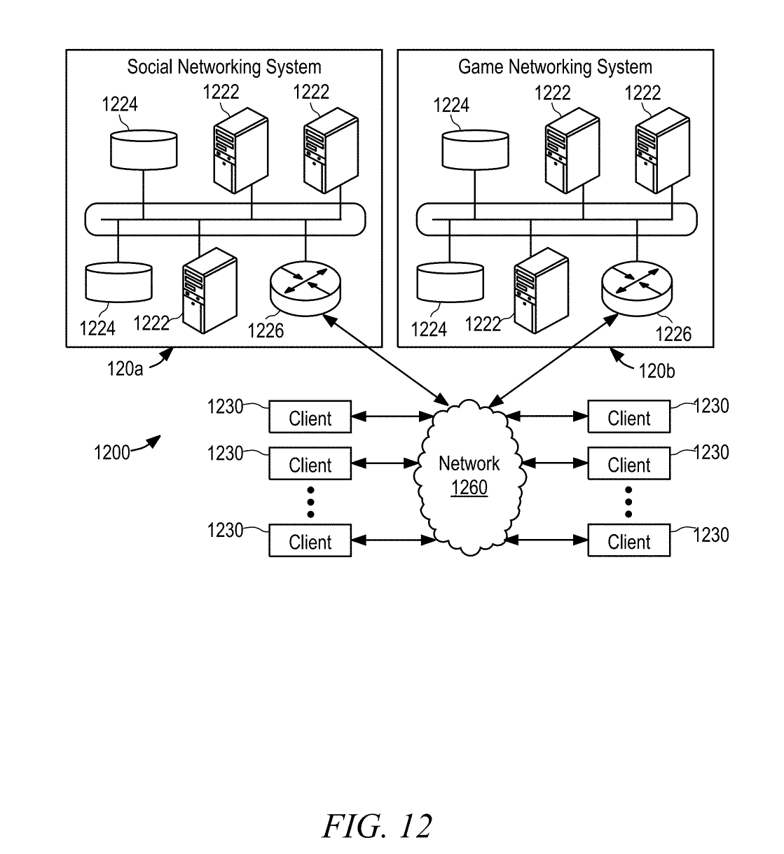

As FIG. 12 illustrates, particular embodiments may operate in a network environment 1200 comprising one or more networking systems, such as social networking system 120a, game networking system 120b, and one or more client systems 1230. The components of social networking system 120a and game networking system 120b operate analogously; as such, hereinafter they may be referred to simply at networking system 1220. Client systems 1230 are operably connected to the network environment via a network service provider, a wireless carrier, or any other suitable means.

Networking system 120 is a network addressable system that, in various example embodiments, comprises one or more physical servers 1222 and data stores 1224. The one or more physical servers 1222 are operably connected to computer network 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1222 may host functionality directed to the operations of networking system 1220. Hereinafter servers 1222 may be referred to as server 1222, although server 1222 may include numerous servers hosting, for example, networking system 1220, as well as other content distribution servers, data stores, and databases. Data store 1224 may store content and data relating to, and enabling, operation of networking system 1220 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In particular embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1230 to enter addresses of specific network resources to be retrieved, such as resources hosted by networking system 820. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as target structured document) hosted by networking system 820, the user's web browser, or other document Sequence Generator or suitable client application, formulates and transmits a request to networking system 1220. The request generally includes a URL or other document identifier as well as metadata or other information. By way of example, the request may include information identifying the user, such as a user ID, as well as information identifying or characterizing the web browser or operating system running on the user's client computing device 1230. The request may also include location information identifying a geographic location of the user's client system or a logical network location of the user's client system. The request may also include a timestamp identifying when the request was transmitted.

Although the example network environment described above and illustrated in FIG. 12 described with respect to social networking system 120a and game networking system 120b, this disclosure encompasses any suitable network environment using any suitable systems. As an example and not by way of limitation, the network environment may include online media systems, online reviewing systems, online search engines, online advertising systems, or any combination of two or more such systems.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Miscellaneous

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer system comprising:
a processor;
a memory device holding an instruction set executable on the processor to cause the computer system to perform operations comprising:
generating first object data based on a first physical gesture applied to a display position of a first object presented in a first instance of a mobile device view of a virtual environment displayed at a first mobile device;
generating second object data based on a second physical gesture applied to a display position of a second object presented in a second instance of the mobile device view of the virtual environment displayed at a second mobile device, the first object and the second object both concurrently displayed in the first and second instances of the mobile device view and a virtual reality view of the virtual environment displayed at a virtual reality device; and
concurrently causing display of the first object data and the second object data in the first and second instances of the mobile device view and the virtual reality view.

2. The computer system of claim 1, comprising:
generating the first instance of the mobile device view of the virtual environment according to a visual perspective of a first player;
generating the second instance of the mobile device view of the virtual environment according to a visual perspective of a second player; and
generating the virtual reality view of the virtual environment according to a visual perspective of a third player associated with the virtual reality device.

3. The computer system of claim 2, wherein generating the first and the second instances of the mobile device view comprises:
generating the first and the second instances of the mobile device view to include a representation of the third player associated with the virtual reality device.

4. The computer system of claim 3, wherein generating the virtual reality view of the virtual environment according to a visual perspective of a third player associated with the virtual reality device comprises:
generating the virtual reality view to include a portion of the representation of the third player associated with the virtual reality device.

5. The computer system of claim 4, comprising:
wherein generating first object data based on a first physical gesture comprises:
generating first object movement data according to a characteristic of the first physical gesture; and
wherein generating second object data based on a second physical gesture comprises:
generating second object movement data according to a characteristic of the first physical gesture.

6. The computer system of claim 5, wherein concurrently causing display of the first object data and the second object data in the first and second instances of the mobile device view and the virtual reality view comprises:
causing display of the first and the second object movement data in the first instance of the mobile device view according to the visual perspective of the first player;
causing display of the first and the second object movement data in the second instance of the mobile device view according to the visual perspective of the second player; and
causing display of the first and the second object movement data in the virtual reality view according to the visual perspective of the third player associated with the virtual reality device.

7. The computer system of claim 6, further comprising:
wherein causing display of the first and the second object movement data in the first instance of the mobile device view according to the visual perspective of the first player comprises:
causing display of both the first object and the second object moving towards the representation of the third player associated with the virtual reality device;
wherein causing display of the first and the second object movement data in the second instance of the mobile device view according to the visual perspective of the second player comprises:
causing display of both the first object and the second object moving towards the representation of the third player associated with the virtual reality device; and
causing display of the first and the second object movement data in the virtual reality view according to the visual perspective of the third player associated with the virtual reality device comprises:
causing display of both the first object and the second object moving towards the portion of the representation of the third player associated with the virtual reality device.

8. A method comprising:
generating first object data based on a first physical gesture applied to a display position of a first object presented in a first instance of a mobile device view of a virtual environment displayed at a first mobile device;
generating second object data based on a second physical gesture applied to a display position of a second object presented in a second instance of the mobile device view of the virtual environment displayed at a second mobile device, the first object and the second object both concurrently displayed in the first and second instances of the mobile device view and a virtual reality view of the virtual environment displayed at a virtual reality device; and
concurrently, by at least one processor, causing display of the first object data and the second object data in the first and second instances of the mobile device view and the virtual reality view.

9. The method of claim 8, comprising:
generating the first instance of the mobile device view of the virtual environment according to a visual perspective of a first player;
generating the second instance of the mobile device view of the virtual environment according to a visual perspective of a second player; and
generating the virtual reality view of the virtual environment according to a visual perspective of a third player associated with the virtual reality device.

10. The method of claim 9, wherein generating the first and the second instances of the mobile device view comprises:
generating the first and the second instances of the mobile device view to include a representation of the third player associated with the virtual reality device.

11. The method of claim 10, wherein generating the virtual reality view of the virtual environment according to a visual perspective of a third player associated with the virtual reality device comprises:
generating the virtual reality view to include a portion of the representation of the third player associated with the virtual reality device.

12. The method of claim 11, comprising:
wherein generating first object data based on a first physical gesture comprises:
generating first object movement data according to a characteristic of the first physical gesture; and
wherein generating second object data based on a second physical gesture comprises:
generating second object movement data according to a characteristic of the first physical gesture.

13. The method of claim 12, wherein concurrently causing display of the first object data and the second object data in the first and second instances of the mobile device view and the virtual reality view comprises:
causing display of the first and the second object movement data in the first instance of the mobile device view according to the visual perspective of the first player;
causing display of the first and the second object movement data in the second instance of the mobile device view according to the visual perspective of the second player; and
causing display of the first and the second object movement data in the virtual reality view according to the visual perspective of the third player associated with the virtual reality device.

14. The method of claim 13, further comprising:
wherein causing display of the first and the second object movement data in the first instance of the mobile device view according to the visual perspective of the first player comprises:
causing display of both the first object and the second object moving towards the representation of the third player associated with the virtual reality device;
wherein causing display of the first and the second object movement data in the second instance of the mobile device view according to the visual perspective of the second player comprises:
causing display of both the first object and the second object moving towards the representation of the third player associated with the virtual reality device; and
causing display of the first and the second object movement data in the virtual reality view according to the visual perspective of the third player associated with the virtual reality device comprises:
causing display of both the first object and the second object moving towards the portion of the representation of the third player associated with the virtual reality device.

15. A non-transitory computer-readable medium storing executable instructions thereon,
which, when executed by a processor, cause the processor to perform operations including:
generating first object data based on a first physical gesture applied to a display position of a first object presented in a first instance of a mobile device view of a virtual environment displayed at a first mobile device;
generating second object data based on a second physical gesture applied to a display position of a second object presented in a second instance of the mobile device view of the virtual environment displayed at a second mobile device, the first object and the second object both concurrently displayed in the first and second instances of the mobile device view and a virtual reality view of the virtual environment displayed at a virtual reality device; and
concurrently causing display of the first object data and the second object data in the first and second instances of the mobile device view and the virtual reality view.

16. The non-transitory computer-readable medium of claim 15, comprising:
generating the first instance of the mobile device view of the virtual environment according to a visual perspective of a first player;
generating the second instance of the mobile device view of the virtual environment according to a visual perspective of a second player; and
generating the virtual reality view of the virtual environment according to a visual perspective of a third player associated with the virtual reality device.

17. The non-transitory computer-readable medium of claim 16, wherein generating the first and the second instances of the mobile device view comprises:
generating the first and the second instances of the mobile device view to include a representation of the third player associated with the virtual reality device.

18. The non-transitory computer-readable medium of claim 17, wherein generating the virtual reality view of the virtual environment according to a visual perspective of a third player associated with the virtual reality device comprises:
generating the virtual reality view to include a portion of the representation of the third player associated with the virtual reality device.

19. The non-transitory computer-readable medium of claim 18, comprising:
wherein generating first object data based on a first physical gesture comprises:
generating first object movement data according to a characteristic of the first physical gesture; and
wherein generating second object data based on a second physical gesture comprises:
generating second object movement data according to a characteristic of the first physical gesture.

20. The non-transitory computer-readable medium of claim 19, wherein concurrently causing display of the first object data and the second object data in the first and second instances of the mobile device view and the virtual reality view comprises:
causing display of the first and the second object movement data in the first instance of the mobile device view according to the visual perspective of the first player;
causing display of the first and the second object movement data in the second instance of the mobile device view according to the visual perspective of the second player; and
causing display of the first and the second object movement data in the virtual reality view according to the visual perspective of the third player associated with the virtual reality device.
